(19) United States
(12) Patent Application Publication
(10) Pub. No.: US 2022/0013079 A1
(43) Pub. Date: Jan. 13, 2022

(54) DEBUGGING METHOD, DISPLAY DEVICE DRIVING METHOD, AND DISPLAY DEVICE

(71) Applicants: HKC CORPORATION LIMITED, Shenzhen (CN); CHONGQING HKC OPTOELECTRONICS TECHNOLOGY CO., LTD., Chongqing (CN)

(72) Inventors: YUNCHUAN HU, Chongqing (CN); WENQIN ZHAO, Chongqing (CN)

(21) Appl. No.: 17/289,231

(22) PCT Filed: Mar. 11, 2020
(86) PCT No.: PCT/CN2020/078700

§ 371 Date: Apr. 28, 2021

(30) Foreign Application Priority Data
Mar. 22, 2019 (CN) 201910219916.9

(51) Int. Cl. G09G 3/36

(52) U.S. Cl. CPC G09G 3/3696; G09G 2320/0276

(57) ABSTRACT

The present application discloses a debugging method, a display device driving method, and a display device. The debugging method includes the following steps: generating gamma correction information; and burning, by a testing machine, the gamma correction information into a source driver board of a display device, where the display device further includes a control board, the control board integrates a gamma chip, and the gamma chip obtains the gamma correction information from the source driver board.

### CROSS-REFERENCE TO RELATED APPLICATIONS

The present application claims priority to the Chinese Patent Application No. CN201910219916.9, filed with the China National Intellectual Property Administration on Mar. 22, 2019 and entitled “DEBUGGING METHOD, DISPLAY DEVICE DRIVING METHOD, AND DISPLAY DEVICE”, which is incorporated herein by reference in its entirety.

### TECHNICAL FIELD

The present application relates to the field of display technologies, and in particular, to a debugging method, a display device driving method, and a display device.

### BACKGROUND

The statements herein only provide background information related to the present application, and do not necessarily constitute related art.

With the continuous development of liquid crystal display technologies, display devices have been widely used in various fields such as televisions, vehicles, mobile communications, and medical care. Customers have increasingly high requirements for image quality. However, due to differences in processes and materials of panel factories, gamma (voltage-brightness) curves of display panels in the thin film transistor-liquid crystal display (TFT-LCD) deviate. To ensure that each display panel satisfies the customers' specifications, it is necessary to provide a system architecture for automatic gamma adjustment (that is, auto P-gamma). The system architecture theoretically calculates target brightness and re-corrects brightness of each gamma to the target brightness, and corrects each panel so that the gamma curve satisfies the specifications.

As the size of the display panel becomes increasingly large, the printed circuit board assembly (PCBA) of the panel factory may be currently shipped using an architecture with X/C separation, that is, the panel and the control board (CB) are shipped separately. In this case, the gamma correction information may be incorrect.

### SUMMARY

The objective of the present application is to provide a debugging method, a display device driving method, and a display device that can effectively ensure correctness of gamma correction information.

The present application discloses a debugging method, applied to a display device, where the debugging method includes the following steps:

generating gamma correction information; and
burning, by a testing machine, the gamma correction information into a source driver board of the display device, where
the display device further includes a control board, the control board integrates a gamma chip, and the gamma chip obtains the gamma correction information from the source driver board.

The present application further discloses a display device, where the display device includes a display panel and a driver circuit, the driver circuit includes a control board and a source driver board, the control board integrates a gamma chip, the source driver board includes a memory, the memory stores gamma correction information, the gamma chip obtains the gamma correction information from the memory, and the gamma chip converts the obtained gamma correction information into an actually required gamma voltage to drive the display panel of the display device.

The present application further discloses a display device driving method, where the driving method includes the following steps:

reading pre-stored gamma correction information from a source driver board in a display device and storing the gamma correction information in a gamma chip in a control board of the display device; and
converting, by the gamma chip in the control board of the display device, the gamma correction information into an actually required gamma voltage to drive a display panel of the display device.

In the present application, gamma correction information corresponding to a display panel in each display device is obtained through debugging using a machine, and debugged gamma information is burned into a source driver board of the display device. Even if, due to its large size, the display device needs to be shipped by separating the panel and the source driver board, this debugging method can still be used to ensure that the burned gamma information is correct, and that the display device can be used properly at the customer's home after the panel and the source driver board in the display device are shipped separately.

### BRIEF DESCRIPTION OF DRAWINGS

The included drawings are intended to provide a further understanding of one or more embodiments of the present application, which constitute a part of the specification. The drawings are used to illustrate the implementations of the present application, and together with the text description, explain the principle of the present application. Clearly, the drawings in the following description are merely some embodiments of the present application. A person of ordinary skill in the art can derive other drawings from these drawings without creative efforts. In the drawings:

FIG. 1 is a schematic flowchart of a debugging method according to one or more embodiments of the present application;

FIG. 2 is a schematic diagram of a testing machine and a display device according to one or more embodiments of the present application;

FIG. 3 is a schematic flowchart of a check step according to one or more embodiments of the present application;

FIG. 4 is a schematic flowchart of a verification step according to one or more embodiments of the present application;

FIG. 5 is a schematic flowchart of a driving method according to one or more embodiments of the present application; and

FIG. 6 is a schematic diagram of a display device according to one or more embodiments of the present application.

### DETAILED DESCRIPTION OF EMBODIMENTS

It should be understood that the used terms, and the disclosed specific structures and functional details herein are merely for describing one or more specific embodiments and are representative. However, the present application can be specifically implemented in many alternative forms, and should not be interpreted to be limited to one or more embodiments described herein.

The terms “first” and “second” in the description of the present application are merely intended for a purpose of description, and should not be understood as an indication of relative importance or an implicit indication of a quantity of indicated technical features. Hence, unless otherwise stated, the features defined by “first” and “second” can explicitly or implicitly include one or more features; and “a plurality of” means two or more. The term “include” and any variations thereof are intended to cover a non-exclusive inclusion, and there may be the presence or addition of one or more other features, integers, steps, operations, elements, components and/or combinations thereof.

In addition, the orientation or position relationships indicated by the terms “center”, “transversal”, “upper”, “lower”, “left”, “right”, “vertical”, “horizontal”, “top”, “bottom”, “inner”, “outer”, etc. are based on the orientation or position relationships shown in the drawings, for ease of the description of the present application and simplifying the description only, rather than indicating that the indicated device or element must have a particular orientation or be constructed and operated in a particular orientation. Therefore, these terms should not be understood as a limitation on the present application.

In addition, unless otherwise specified and defined, the terms “install”, “connected with”, and “connected to” should be comprehended in a broad sense. For example, these terms may be comprehended as being fixedly connected, detachably connected or integrally connected; mechanically or electrically connected; or directly connected or indirectly connected through an intermediate medium, or in internal communication between two elements. The specific meanings about the foregoing terms in the present application may be understood by a person of ordinary skill in the art depending on specific circumstances.

The following further describes the present application with reference to drawings and one or more optional embodiments.

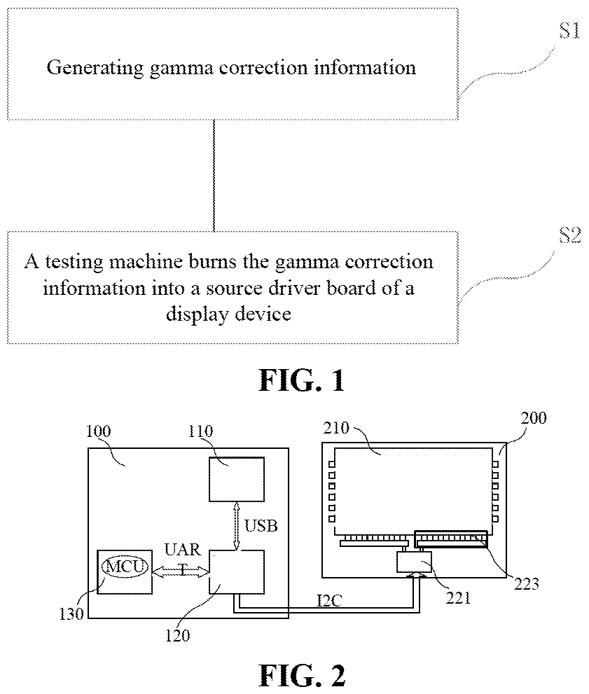

As shown in FIG. 1, an embodiment of the present application discloses a debugging method, where the debugging method includes the following steps:

S1: Generating gamma correction information.

S2: A testing machine burns the gamma correction information into a source driver board of a display device.

The display device further includes a control board, the control board integrates a gamma chip, and the gamma chip obtains the gamma correction information from the source driver board.

The present application first provides a testing machine shown in FIG. 2. The testing machine 100 includes a processor 110 (computer, PC), a pattern generator 120 (pattern generator, PG), and a sensor board 130 (sensor board). The sensor board 130 may include a photoelectric sensor, or may be another device or circuit that has a function of collecting brightness and flicker data of a display panel 210 in a display device 200. The sensor board 130 collects the brightness and flicker data of the detected display panel, and gamma data is automatically adjusted based on the collected brightness and flicker data of the display panel. Such cooperation of the testing machine and the display panel forms a system architecture for automatic gamma adjustment.

Specifically, the sensor board collects the brightness and flicker data of the display panel, which are usually calculated by a microprogrammed control unit (MCU) and then transmitted to the pattern generator 120 by a universal asynchronous receiver/transmitter (UART). The pattern generator PG is usually connected to the processor via a USB. On one hand, the PG transmits the data collected by the sensor board to the PC, and on the other hand, the PG transmits an image to the panel and communicates with a digital gamma (DG) circuit on the panel through a bidirectional serial bus (12C) interface. The current brightness is obtained by the photoelectric sensor, target brightness is theoretically calculated, and brightness of each gamma binding point is re-corrected to the target brightness. Each display panel is corrected so that a gamma curve satisfies specifications. In a large-size liquid crystal display panel, a display panel 210 and a control board 221 in a display device are usually shipped separately. In view of this, the testing machine burns the gamma correction information into the source driver board 223 of the display panel. Even if the display panel and the control board are shipped separately, there is no need to worry about the correctness of the gamma information because the burned gamma information has been recorded in the display device.

Certainly, a check step may be further added to verify whether the burned information is correct, so as to ensure that the customer can use the product properly when receiving the product. After step S2, the method further includes the check step:

S3: Reading the burned gamma correction information from the source driver board and check it against the gamma correction information in the testing machine; if the check succeeds, the product is shipped normally; if the check fails, the gamma correction information is generated and burned again.

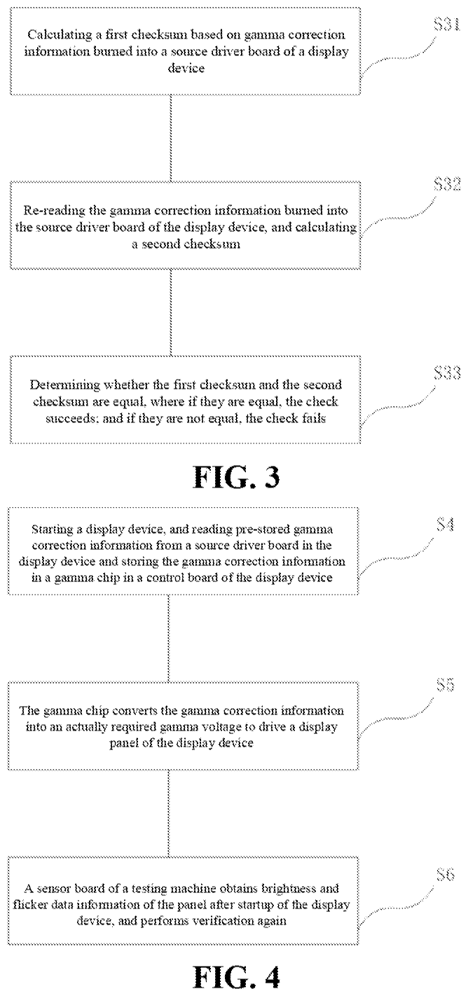

As shown in FIG. 3, to make the check step more convincing and ensure the correctness of the information, comparison is performed based on specific values. The check step for comparison may include the following steps:

S31: Calculating a first checksum based on the gamma correction information burned into the source driver board of the display device.

S32: Re-reading the gamma correction information burned into the source driver board of the display device, and calculate a second checksum.

S33: Determining whether the first checksum and the second checksum are equal, where if they are equal, the check succeeds; and if they are not equal, the check fails.

The burned information may be usually incomplete. For this reason, the first checksum is calculated based on the gamma correction information burned into the source driver board of the display device; then, the gamma correction information burned into the source driver board of the display device is re-read, and the second checksum is calculated, so as to further ensure the correctness of the burned information, and make the data more convincing through calculation and comparison.

As shown in FIG. 4, in one or more embodiments, a verification step may be further added, which is different from the foregoing check step. Depending on actual situations, this verification step specifically includes the following steps:

S4: Start a display device, and read pre-stored gamma correction information from a source driver board in the display device and store the gamma correction information in a gamma chip in a control board of the display device.

S5: The gamma chip converts the gamma correction information into an actually required gamma voltage to drive a display panel of the display device.

S6: A sensor board of a testing machine obtains brightness and flicker data information of the panel after startup of the display device, and performs verification again.

After completion of the debugging performed using the testing machine and before shipment, to further ensure the correctness of the previously burned gamma information, verification and comparison are performed again using the testing machine.

In the step in which the sensor board of the testing machine obtains the brightness and flicker data information of the panel after startup of the display device, and performs verification again, the obtained brightness and flicker data information of the panel after startup of the display device are verified against the gamma correction information; if the verification succeeds, the product is shipped normally; and if the verification fails, the gamma correction information is generated and burned again.

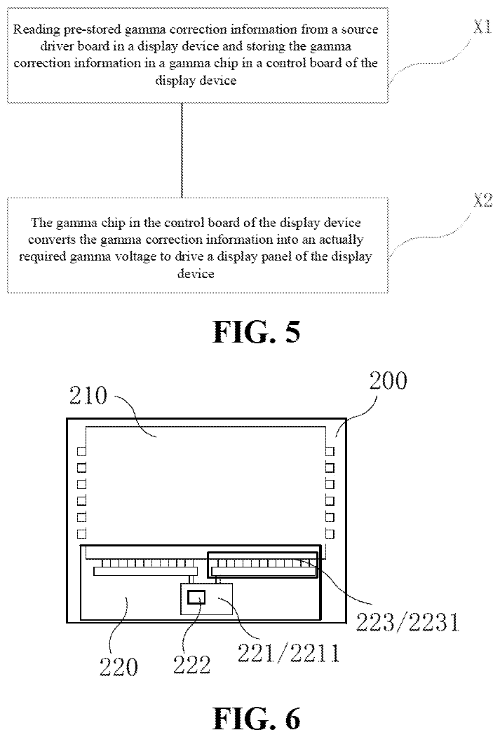

As shown in FIG. 5, in one or more embodiments of the present application, a display device driving method is disclosed, where the driving method includes the following steps:

X1: Reading pre-stored gamma correction information from a source driver board in a display device and store the gamma correction information in a gamma chip in a control board of the display device.

X2: The gamma chip in the control board of the display device converts the gamma correction information into an actually required gamma voltage to drive a display panel of the display device.

FIG. 6 shows a corresponding display device 200. The display device includes a display panel 210 and a driver circuit 220. The driver circuit 220 includes a control board 221 and a source driver board 223. The control board 221 integrates a gamma chip 222. The source driver board 223 includes a memory 2231. The memory 2231 stores gamma correction information. The gamma chip obtains the gamma correction information from the memory. The gamma chip converts the obtained gamma correction information into an actually required gamma voltage to drive the display panel of the display device.

The control board 221 further includes a timing control chip 2211. In the step of reading pre-stored gamma correction information from a source driver board in a display device and storing the gamma correction information in a gamma chip in a control board of the display device, the timing control chip reads the pre-stored gamma correction information from the source driver board and stores the gamma correction information in the gamma chip in the control board of the display device.

The memory 2231 includes a programmable memory chip (EEPROM), and the gamma correction information is stored in the programmable memory chip. In the step of reading pre-stored gamma correction information from a source driver board in a display device and storing the gamma correction information in a gamma chip in a control board of the display device, the pre-stored gamma correction information is read from the programmable memory chip in the source driver board and is stored in the gamma chip in the control board of the display device.

It should be noted that the restriction for each step included in this solution is not considered as a limitation on a sequence of the steps without affecting specific implementation of the solution. The steps described first may be performed first, may be performed later, or even may be performed simultaneously, provided that this solution can be implemented, which should be considered as falling within the protection scope of the present application.

The technical solutions of the present application can be widely used in various display panels, such as a twisted nematic (TN) display panel, an in-plane switching (IPS) display panel, a vertical alignment (VA) display panel, and a multi-domain vertical alignment (MVA) display panel, or may certainly be used in other types of display panels, such as an organic light-emitting diode (OLED) display panel. The foregoing solutions are applicable to all these display panels.

The foregoing content further describes the present application in detail with reference to one or more specific optional embodiments, and the specification should not be construed as a limitation on the one or more specific embodiments of the present application. A person of ordinary skill in the art to which the present application pertains may make some simple derivations or replacements without departing from the idea of the present application, and the derivations or replacements should all fall within the protection scope of the present application.

What is claimed is:

1. A debugging method, applied to a display device, wherein the debugging method comprises the following steps:
generating gamma correction information; and
burning, by a testing machine, the gamma correction information into a source driver board of the display device, wherein
the display device further comprises a control board, the control board integrates a gamma chip, and the gamma chip obtains the gamma correction information from the source driver board.

2. The debugging method according to claim 1, after the step of burning, by a testing machine, the gamma correction information into a source driver board of the display device, further comprising a check step:
reading the burned gamma correction information from the source driver board and checking it against the gamma correction information in the testing machine, wherein if the check succeeds, the product is shipped normally; and if the check fails, the gamma correction information is generated and burned again.

3. The debugging method according to claim 2, wherein the step of reading the burned gamma correction information from the source driver board and checking it against the gamma correction information in the testing machine, wherein if the check succeeds, the product is shipped normally; and if the check fails, the gamma correction information is generated and burned again, comprises:
calculating a first checksum based on the gamma correction information burned into the source driver board of the display device;
re-reading the gamma correction information burned into the source driver board of the display device, and calculating a second checksum; and
determining whether the first checksum and the second checksum are equal, wherein if they are equal, the check succeeds; and if they are not equal, the check fails.

4. The debugging method according to claim 3, wherein the testing machine comprises a processor, and in the step of determining whether the first checksum and the second checksum are equal, wherein if they are equal, the check succeeds; and if they are not equal, the check fails, the first checksum and the second checksum are calculated by the processor.

5. The debugging method according to claim 1, after the step of burning, by a testing machine, the gamma correction information into a source driver board of the display device, further comprising verification steps:
starting the display device, and reading pre-stored gamma correction information from the source driver board in the display device and storing the gamma correction information in the gamma chip in the control board of the display device;
converting, by the gamma chip, the gamma correction information into an actually required gamma voltage to drive a display panel of the display device; and
obtaining, by a sensor board of the testing machine, brightness and flicker data information of the panel after startup of the display device, and performing verification again.

6. The debugging method according to claim 5, wherein the testing machine comprises a sensor, and the step of generating gamma correction information comprises:
collecting, by the sensor, the data information of the display panel, and calculating target brightness, to generate the gamma correction information.

7. The debugging method according to claim 5, wherein the sensor board of the testing machine comprises a photoelectric sensor, and the step of generating gamma correction information comprises:
obtaining, by the photoelectric sensor of the testing machine, current brightness of the display panel, and calculating target brightness, to generate the gamma correction information.

8. The debugging method according to claim 5, wherein the testing machine further comprises a pattern generator and a processor; and in the step of starting the display device, and reading pre-stored gamma correction information from the source driver board in the display device and storing the gamma correction information in the gamma chip in the control board of the display device,
the data collected by the sensor board of the testing machine is adjusted and then transmitted to the processor, and the pattern generator of the testing machine transmits a preset image to the display panel.

9. The debugging method according to claim 8, wherein the pattern generator of the testing machine communicates with a digital gamma circuit on the display panel through a bidirectional serial bus.

10. The debugging method according to claim 8, wherein the sensor board comprises a microprogrammed control unit; and in the step of obtaining, by a sensor board of the testing machine, brightness and flicker data information of the panel after startup of the display device, and performing verification again,
the sensor board collects the brightness and data of the display panel, which are calculated by the microprogrammed control unit and then transmitted to the pattern generator by a universal asynchronous receiver/transmitter.

11. The debugging method according to claim 5, wherein in the step of obtaining, by a sensor board of the testing machine, brightness and flicker data information of the panel after startup of the display device, and performing verification again,
the obtained brightness and flicker data information of the panel after startup of the display device are verified against the gamma correction information; if the verification succeeds, the product is shipped normally; and if the verification fails, the gamma correction information is generated and burned again.

12. A display device, wherein the display device comprises a display panel and a driver circuit, and the driver circuit comprises:
a control board, wherein the control board integrates a gamma chip; and
a source driver board, wherein the source driver board comprises a memory, and the memory stores gamma correction information, wherein
the gamma chip obtains the gamma correction information from the memory, and the gamma chip converts the obtained gamma correction information into an actually required gamma voltage to drive the display panel.

13. The display device according to claim 12, wherein the control board further comprises a timing control chip, and the timing control chip reads the pre-stored gamma correction information from the source driver board and stores the gamma correction information in the gamma chip.

14. The display device according to claim 12, wherein the memory comprises a programmable memory chip, and the gamma correction information is stored in the programmable memory chip.

15. A display device driving method, applied to the display device according to claim 11, wherein the driving method comprises the following steps:
reading pre-stored gamma correction information from a source driver board in the display device and storing the gamma correction information in a gamma chip in a control board of the display device; and
converting, by the gamma chip in the control board of the display device, the gamma correction information into an actually required gamma voltage to drive a display panel of the display device.

16. The display device driving method according to claim 15, wherein the control board of the display device comprises a timing control chip; and in the step of reading pre-stored gamma correction information from a source driver board in the display device and storing the gamma correction information in a gamma chip in a control board of the display device, the timing control chip reads the pre-stored gamma correction information from the source driver board and stores the gamma correction information in the gamma chip in the control board of the display device.

17. The display device driving method according to claim 15, wherein in the step of reading pre-stored gamma correction information from a source driver board in the display device and storing the gamma correction information in a gamma chip in a control board of the display device,
the gamma correction information is stored in a programmable memory chip in the source driver board, and the pre-stored gamma correction information is read from the programmable memory chip in the source driver board and stored in the gamma chip in the control board of the display device.

18. The display device driving method according to claim 15, wherein the pre-stored gamma correction information is obtained after burning by a testing machine.
